(19) United States
(12) Patent Application Publication
(10) Pub. No.: US 2003/0115083 A1
(43) Pub. Date: Jun. 19, 2003

(54) HTML-based clinical content

(76) Inventors: Fred E. Masarie JR., Portland, OR (US); David Gerard Gonzalez, Beaverton, OR (US); Jeffrey Alan Fletcher, Portland, OR (US)

Correspondence Address: FOLEY & LARDNER, 777 EAST WISCONSIN AVENUE, SUITE 3800, MILWAUKEE, WI, 53202-5308, US

(21) Appl. No.: 10/290,077

(22) Filed: Nov. 7, 2002

Related U.S. Application Data
(60) Provisional application No. 60/338,263, filed on Nov. 7, 2001.

(51) Int. Cl. G06F 17/60

(52) U.S. Cl. 705/2

(57) ABSTRACT

Systems and methods for electronic medical record and clinical content management are disclosed. A system for creating a medical clinical record template for at least one medical condition or encounter includes a processing unit, and a memory portion in communication with the processing unit having information stored therein to configure the processing unit to receive a first data set relating to the medical condition or encounter; extract at least two data elements from the first data set; provide the at least two data elements to a user to select data elements; receive an indicator of data elements selected by the user; and include the selected data elements into the medical record template.

### CROSS-REFERENCE TO RELATED PATENT APPLICATIONS

The present application claims the benefit of priority as available under 35 U.S.C. § § 119 and 120 of U.S. Patent Application No. 60/338,263 (“HTML-Based Clinical Content”) filed Nov. 7, 2001 (the entire disclosure of this application is incorporated by reference).

### BACKGROUND OF THE INVENTION

The present invention relates generally to the field of electronic medical records (EMR) and clinical content management. The present invention more specifically relates to systems' and methods, which provide for the reconfiguration, customization, implementation, and use of a variety of medical record templates.

It is known to provide for electronic medical record (EMR) management systems and methods. However, conventional EMR management systems and methods do not realize certain advantageous features.

Delivery mechanisms (such as data entry forms, reports, flow sheets, other tools, etc.) may be provided to users (such as a doctor, nurse, medical practitioner, clinician, etc.) in conventional EMR management systems. The delivery mechanisms (such as a data entry form) allow users to document a patient encounter after an interview, examination, medical procedure, or other clinical intervention with a patient. Other delivery mechanisms (such as reports) may be used to study populations of patients for disease management, utilization of resources, and quality of care purposes. However, conventional EMR management systems require labor intensive configuration of the clinical components of their systems, often requiring extensive customization that cannot be leveraged across systems or even delivery mechanisms within a given system.

Thus it would be advantageous to provide a system and method which would allow for the ready configuration, customization, or adaptive use of a template and/or delivery mechanism (such as a form or report) for use with a variety of medical procedures or encounters. It would further the advantageous to provide a system and method which would allow for the separation or externalization of the clinical information required for taking care of patients with specified conditions or requiring specific procedures from a delivery mechansim, e.g., data entry forms, flowsheets, reports, such that this clinical information can be created once and re-used in multiple settings. It would further be advantageous to provide a system and method, which would allow for one or more databases to be accessed in order to generate a template. It would further be advantageous to provide a system and method, which would provide the ability to leverage other, existing content, and data to generate a user defined template. It would further be advantageous to provide a system and method, which would provide the ability to leverage practice patterns through the use of previous patient data in order to build or obtain content for one or more templates.

It would be advantageous to provide a system and method that provides any one or more of these or other advantageous features.

### SUMMARY OF THE INVENTION

One embodiment of the invention relates to a system for creating a clinical template for at least one medical condition or type of patient encounter. The system includes a processing unit, and a memory portion in communication with the processing unit having information stored therein to configure the processing unit to receive a first data set relating to the medical condition or type of patient encounter; extract at least two data elements from the first data set; provide the at least two data elements to a user to select data elements; receive an indicator of data elements selected by the user; and include the selected data elements into the medical record template.

Another embodiment of the invention relates to a method for generating a medical record template for at least one medical condition or type of patient encounter. The method includes receiving a first data set related to the medical condition or type of patient encounter; extracting at least two data elements from the first data set; providing the at least two data elements to a user to select data elements; receiving an indicator of data elements selected by the user; and including the selected data elements into the medical record template.

Another embodiment of the invention relates to a system for generating a medical template for at least one medical condition or type of patient encounter. The system includes a first computer system, and a second computer system in communication with the first computer system. The second computer system is configured to receive a first data set relating to the at least one medical condition or type of patient encounter from the first computer system. The second computer system is configured to generate the medical template from the first data set.

### BRIEF DESCRIPTION OF THE DRAWINGS

FIG. 1 is a schematic representation of a clinical content management system according to an exemplary embodiment.

FIG. 2 is a schematic representation of a method of creating and implementing a template for use with clinical content management according to an exemplary embodiment.

FIG. 3 is a schematic representation of data flow used in creating and implementing a template for use with clinical content management according to an exemplary embodiment.

FIG. 4 is a schematic representation of data flow used in creating and implementing a template for use with clinical content management according to an exemplary embodiment.

FIG. 5 is a user interface for creating a template according to an exemplary embodiment.

FIG. 6 is a schematic representation of a clinical content management system according to an exemplary embodiment.

FIGS. 7 to 19 show a user interface for creating a template according to an exemplary embodiment.

FIG. 20 is a delivery mechanism shown as a data entry form created from the template shown in APPENDIX A, according to an exemplary embodiment.

### DETAILED DESCRIPTION OF THE PREFERRED EMBODIMENTS

Systems and methods for electronic medical record and clinical content management are disclosed. The systems and methods disclosed provide for the reconfiguration, customization, implementation, and use of various templates and/or delivery mechanisms involved with clinical encounters (e.g., examinations, interviews, procedures, diagnoses, laboratory work, tasks, research, etc.).

In clinical contexts, it is desirable to provide delivery mechanisms (such as forms, reports, etc.) to users (e.g., doctors, nurses, medical practitioners, laboratory technicians, etc.). For example, data entry forms may be provided with content or data related to one or more medical conditions or type of patient encounters or tasks. These delivery mechanisms allow users to review and document data. For example, a doctor performing a patient exam may use a delivery mechanism (e.g., form) populated with “medical content” or data fields to record observations and examination data. Furthermore, a doctor may use a delivery mechanism (e.g., a report) to study a human population having a medical condition by identifying relevant data fields, which are to be reviewed or analyzed.

Delivery mechanisms may include or utilize various data types such as subjective patient data, objective patient data, assessment data, and procedure or plan data. Subjective patient data may include history of a present illness, past medical history, family history, etc. Objective patient data may include vital signs (e.g., height, weight, blood pressure, etc.), examination/procedure data, results of blood tests (e.g., cholesterol, LDL, HDL), etc. Assessment data may include a doctor's evaluation or assessment of the patient's condition, diagnosis, etc. Plan data may include a doctor's recommendations, plans, orders, medication prescriptions, etc. for the patient to improve the condition.

It should be appreciated that individual doctors can treat and diagnose the same condition in different ways. For example, two doctors may prescribe two different medications for treatment of the same condition; a family doctor treating congestive heart disease may conduct different examinations and have different order sets than a cardiologist, etc. Thus the delivery mechanisms the doctors use should allow for reconfiguration to accommodate individual needs or preferences.

However, it should also be appreciated that there may be an overlap or common area in the types of data that multiple doctors will use in treatment of the same conditions. For example, it may be common for multiple doctors to obtain the same set of vital signs in any type of examination that they conduct; it may be common for multiple doctors to prescribe the same medication or give the same orders for one condition, etc. Furthermore, an organization (such as a large health system) may require that a condition be handled according to prescribed guidelines (e.g., specific medications should be prescribed for certain conditions, specific exam data should be obtained for certain conditions, etc.). Thus the delivery mechanisms the doctors use should allow for both user configuration as well as support efforts towards standardization of care.

The systems and methods disclosed provide for the generation, population, use, etc. of clinical templates and delivery mechanisms based on both standardized (or common) content, and data fields as well as configurable content and data fields.

A template is a collection of medical content that relates to a specific medical condition, problem or type of patient encounter or issue. For example, a medical condition may be a medical problem, disease or condition. A medical patient encounter may relate to a screening procedure or a routine physical exam. The content may consist of a variety of elements: types of subjective history (location of pain, duration of symptoms, etc.), types of objective findings (quality of foot pulses, temperature, cholesterol level), related diagnoses (an upper respiratory template might list pharyngitis, tonsillitis, sinusitis, viral respiratory infection, etc.), medications and dosing for that medical issue, lab tests that are typically done for the issue (throat culture, chest x-ray), educational resources that may be employed for the issue, and advice that might be dispensed for the issue.

Templates may instantiate as various delivery mechanisms. For example, a template may instantiate as a data input form including the listing of treatment options. The template may instantiate as a historic view (or longitudinal view) of the individual patient record, displaying all those medications, labs, objective findings, etc. of that the patient. The template may also instantiate as a population based view showing the number of patients with that condition, a percentage of the population on each of the medications in the template, etc.

As discussed below, templates may be used to define or determine the content of a delivery mechanism related to a clinical encounter. The delivery mechanism is the useable embodiment of the content of the template. For example, the delivery mechanism may be a form used by a doctor during an examination to record and document data; the delivery mechanism may be a flow sheet used to view and compare/trend data over time; the delivery mechanism may be a report used to study a population, etc.

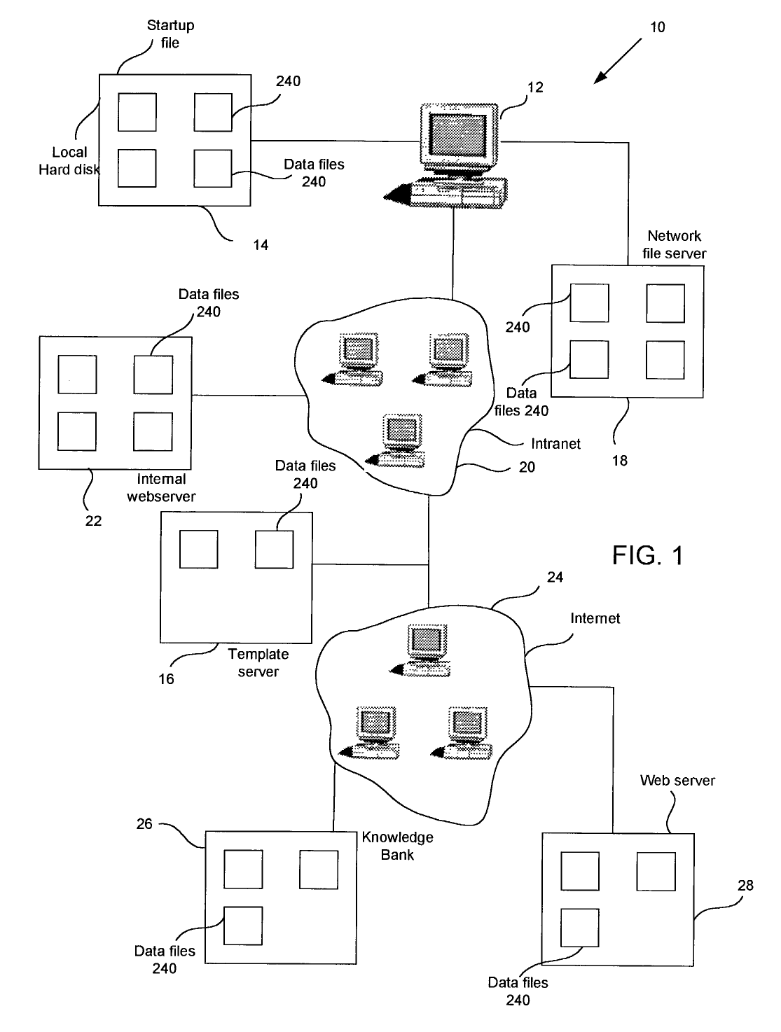

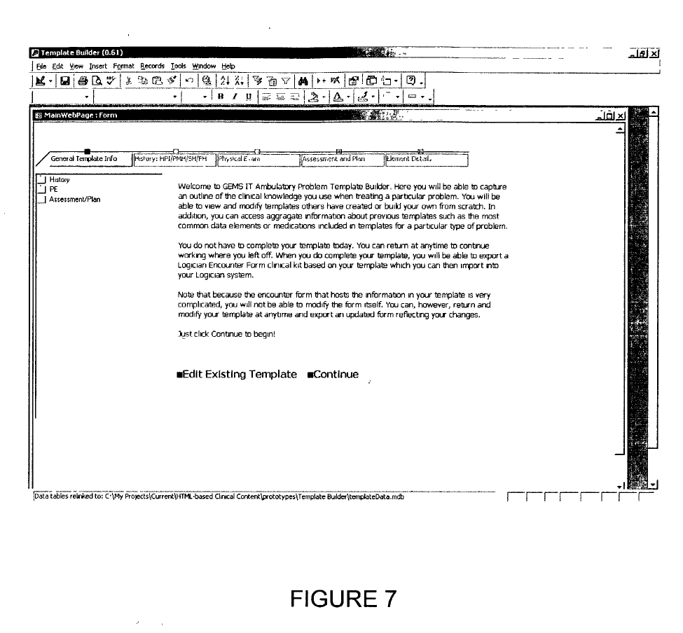

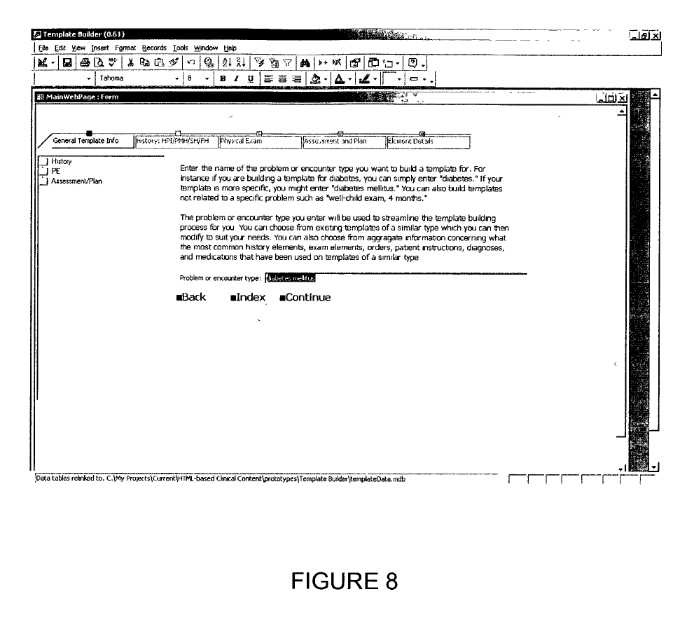

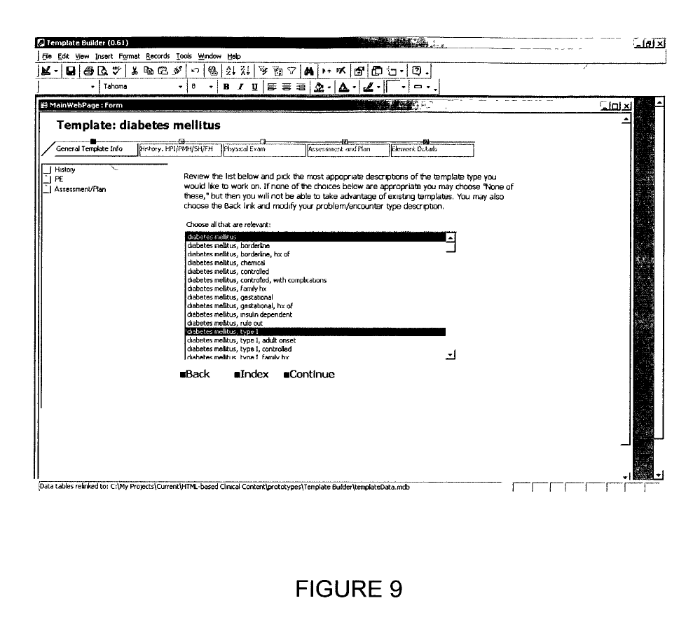

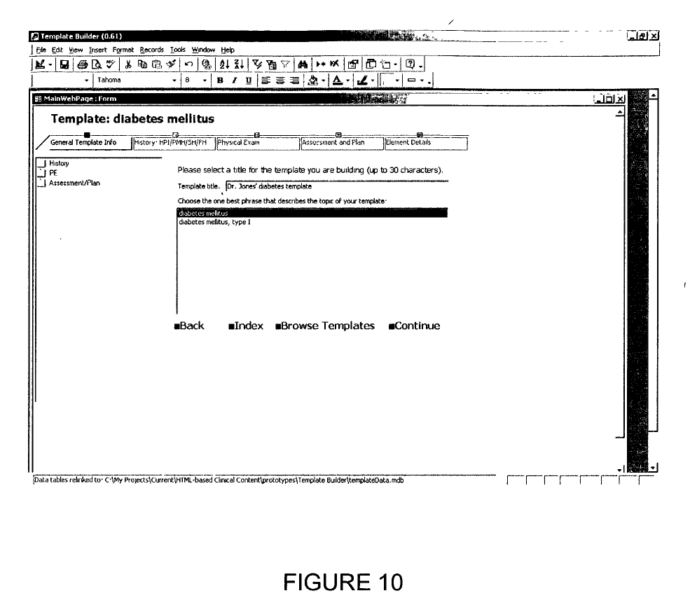

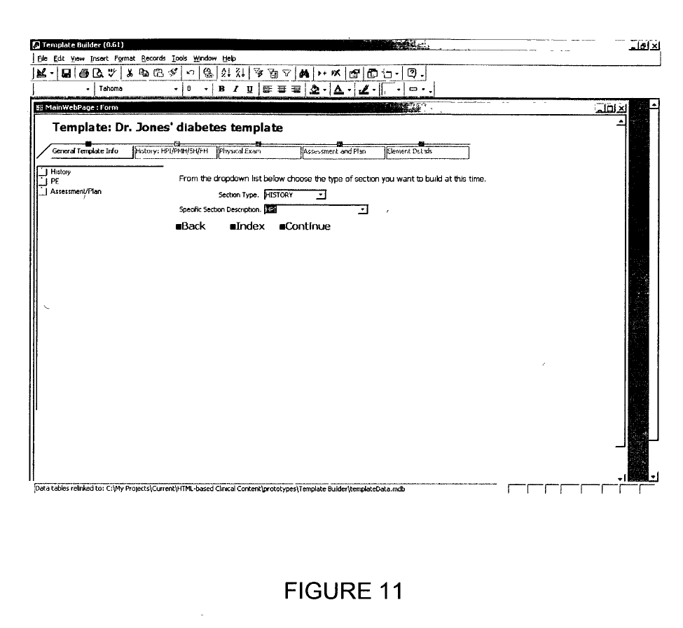

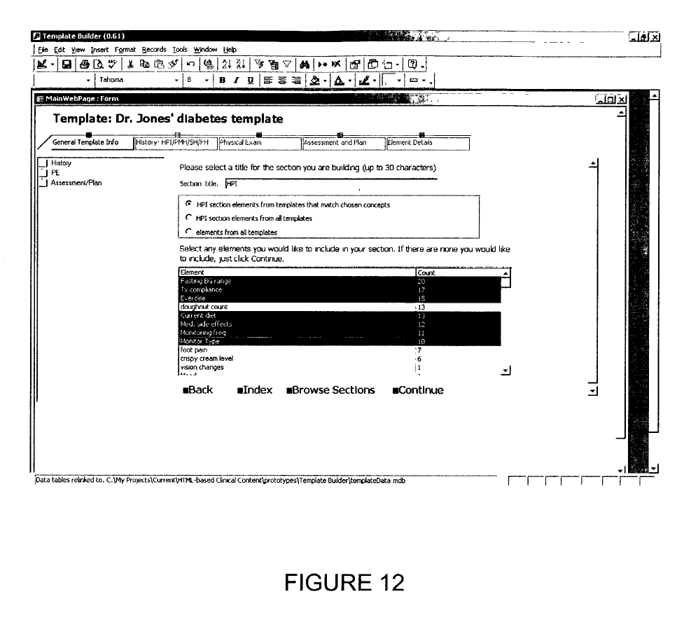

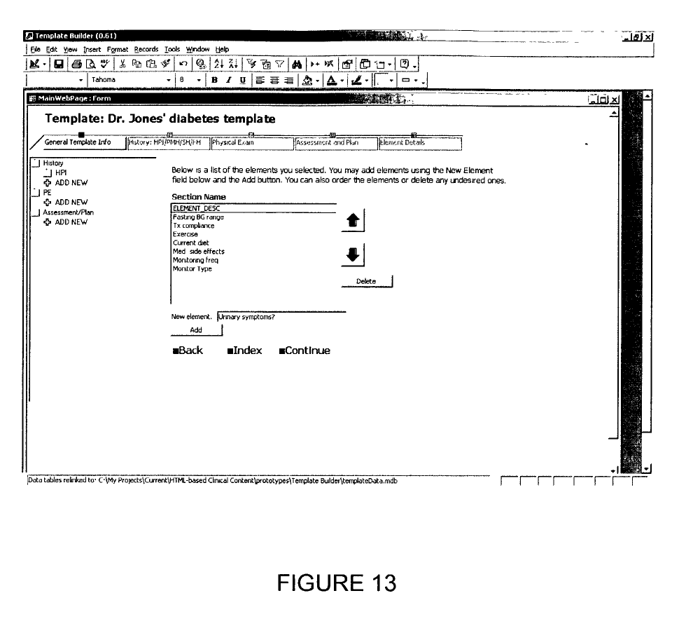

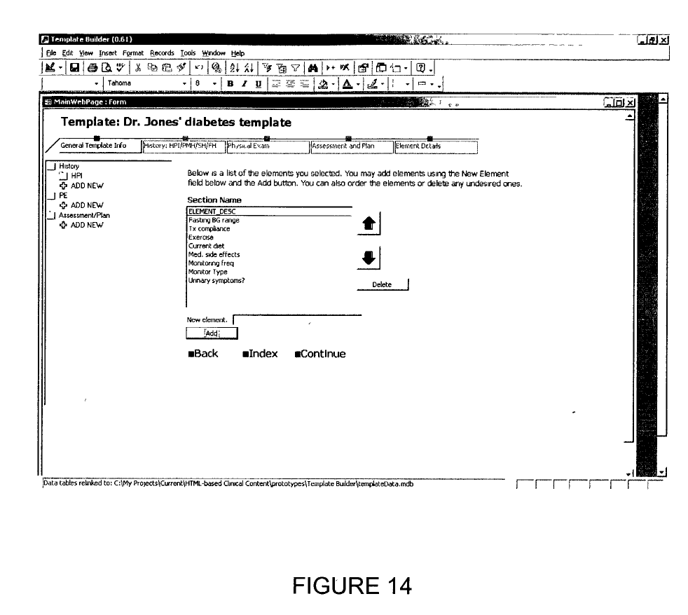

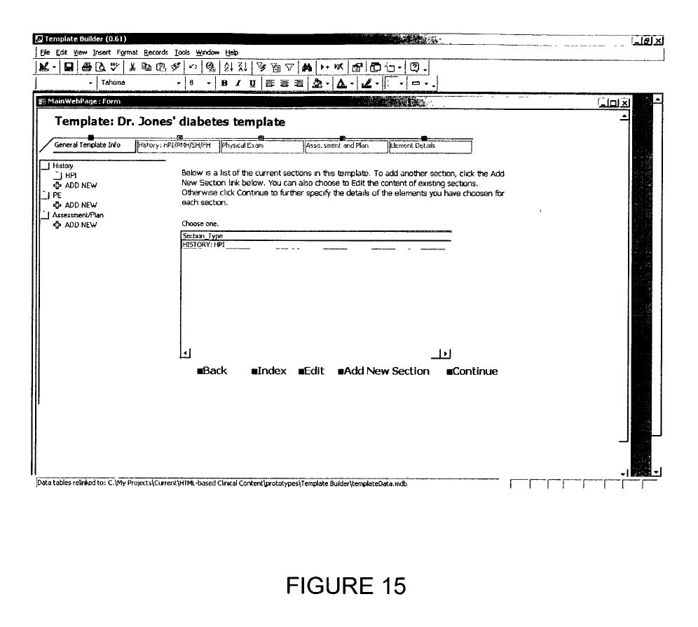

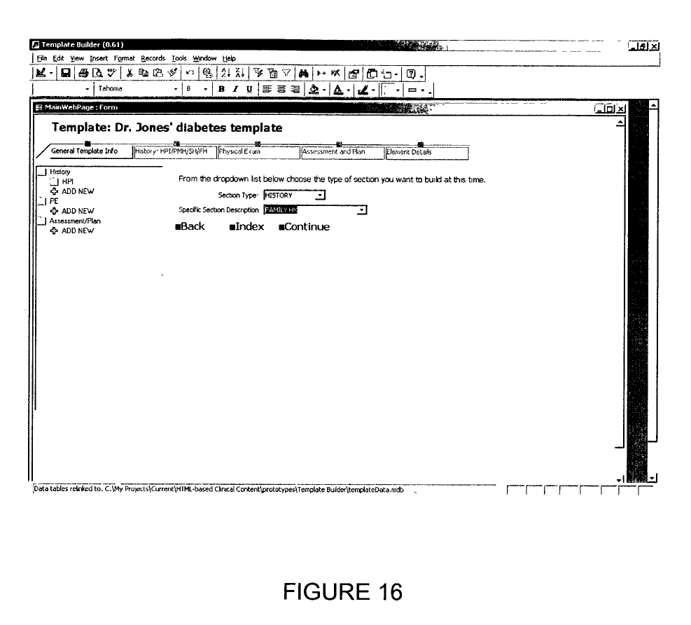

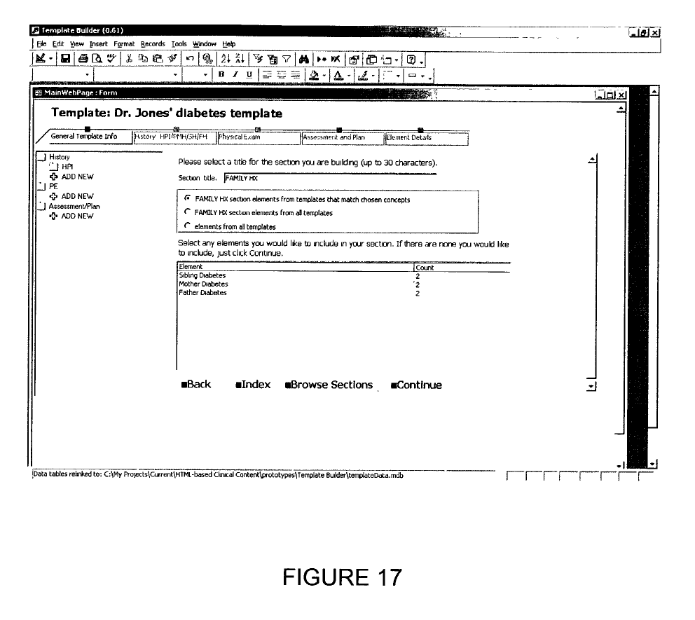

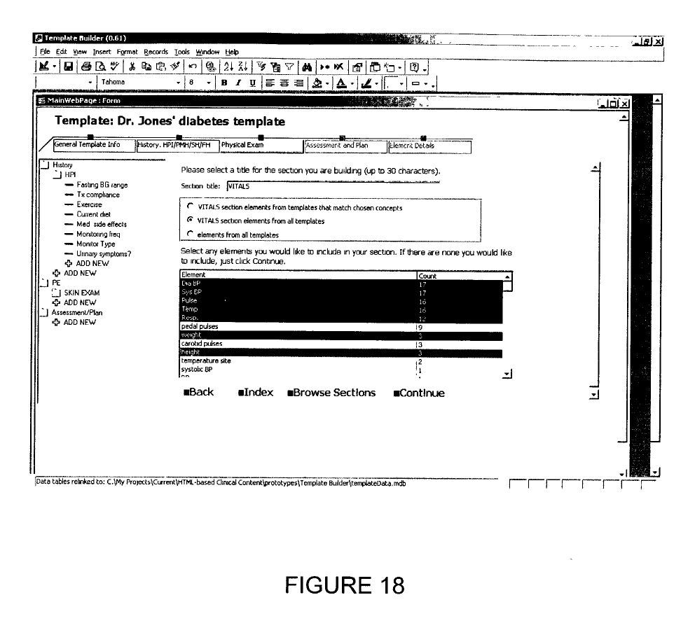

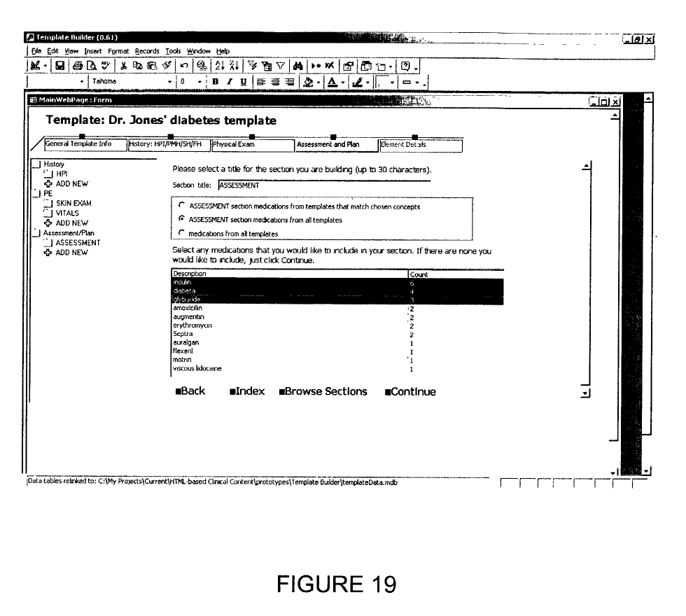

Various exemplary embodiments of clinical template management systems and methods are shown in FIGS. 1-20.

Shown in FIG. 1 is a clinical template management system 10. System 10 may include one or more computer systems which have a central processing unit (CPU) that executes sequences of instructions contained in a memory. More specifically, execution of the sequences of instructions causes the CPU(s) to perform steps, which are described below. The instructions may be loaded into a random access memory (RAM) for execution by the CPU(s) from a read-only memory (ROM), a mass storage device, or some other persistent storage. In other embodiments, hardwired circuitry may be used in place of, or in combination with, software instructions to implement the functions described. Thus, the embodiments described are not limited to any specific combination of hardware, circuitry, computer systems, and software, nor to any particular source for the instructions executed by the one or more computer systems.

According to a particularly preferred embodiment, clinical template management system 10 comprise a portal 12, storage device 14, template server 16, network file server 18, communications network 20, web server 22, communications network 24, database 26, and web server 28.

Portal 12 may provide a user interface to system 10. Portal 12 is in electronic communication with storage device 14 such that data may be stored, accessed, used, and/or provided to a user. According to a particularly preferred embodiment, storage device 14 and portal 12 are part of a single computer system (e.g., desktop computer, laptop computer, etc.).

Network 20 connects portal 12 and web server 22. According to an exemplary embodiment, network 20 is a local area network (LAN). According to an alternative embodiment, network 20 may be any of a variety of networks which provide communications. Web server 22 may be a computer system (such as a desktop computer system) or server configured to communicate and share data with portal 12. Web server 22 may be a server internal to an organization which is used to provide data in order to build, extract, or compile templates.

In an exemplary embodiment, network 24 is the Internet, a worldwide network of computer networks that use various protocols to facilitate data transmission and exchange. Network 24 can use a protocol, such as, the TCP/IP network protocol or the DECnet, X.25, and UDP protocols. In alternative embodiments, network 24 is any type of network, such as, a virtual private network (VPN), an Ethernet, or a Netware network. Further, network 24 can include a configuration, such as, a wide area network (WAN) or a local area network (LAN). Network 24 preferably provides communication for Extensible Markup Language (XML) and Hypertext Markup Language (HTML) files. According to an alternative embodiment, the network may provide communication via other formats and data types, etc.

According to an exemplary embodiment, database 26 and web server 28 may be one or more computer systems or servers in communication with portal 12 via network 24. Database 26 and web server 28 may be computer systems external to an organization, which are used to provide data to in order to build, extract, or compile templates.

Generally, system 10 can be implemented using various computer systems or servers configured by one or more software programs. According to various alternative embodiments, software may be run on a number of different locations, including on the local portal, one or more servers in communication with each other, on a single computer, etc.

A user may access system 10 via a user interface (such as a web page, template creation tool, application server, clinical content server, program, etc.) which may be conveyed to the user at portal 12. According to an exemplary embodiment, portal 12 comprises a computer system. The computer system can be any type of computing device, including work stations, laptops, personal computer systems, notebooks, personal digital assistants (PDAs), cell phones, beepers, or other equipment capable of communication with system 10. Other user interface platforms may also be provided for using system 10. Such user interface platforms include, for example, WAP (wireless application protocol) and web interfaces.

The systems and methods disclosed provide for the generation, population, use, etc. of clinical templates and delivery mechanisms based on both standardized or common content and data as well as configurable content and data. The systems and method disclosed further provide for the externalization or separation of template data from a user interface. That is, the content of the template is separated from the user interface, thus allowing content to be extracted or built once and applied many times for a variety of different purposes or to a variety of different delivery mechanisms.

A template generally is a collection of medical content that relates to a specific medical condition or type of patient encounter. The content may consist of a variety of elements: types of subjective history (location of pain, duration of symptoms, etc.), types of objective findings (quality of foot pulses, temperature, cholesterol level), related diagnoses (an upper respiratory template might list pharyngitis, tonsillitis, sinusitis, viral respiratory infection, etc.), medications and dosing for that medical issue, lab tests that are typically done for the issue (throat culture, chest x-ray), educational resources that may be employed for the issue, and advice that might be dispensed for the issue.

Templates may instantiate as various delivery mechanisms. For example, a template may instantiate as a data input form including the listing of treatment options. The template may instantiate as a historic view (or longitudinal view) of the individual patient record, displaying all those medications, labs, objective findings, etc. of that the patient. The template may also instantiate as a population based view showing the number of patients with that condition, a percentage of the population on each of the medications in the template, etc.

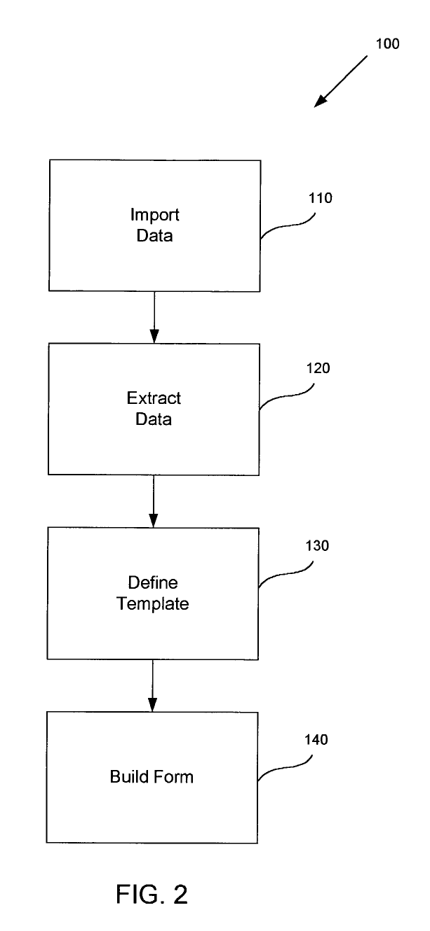

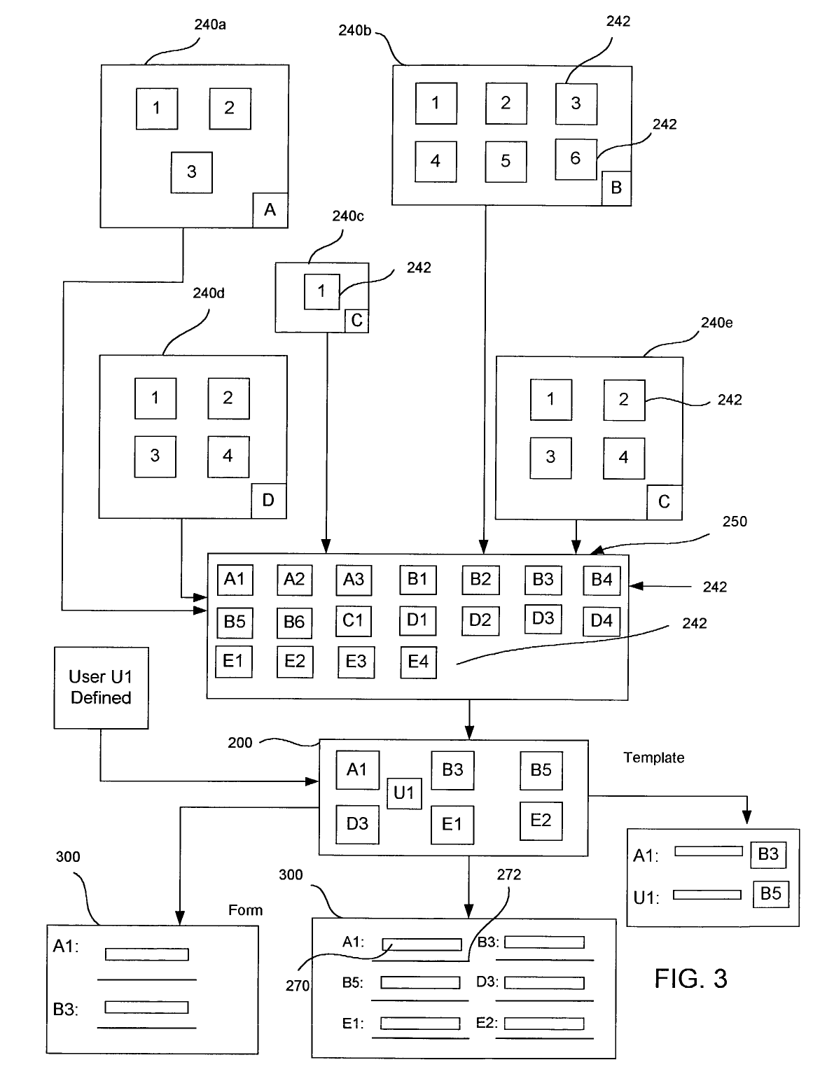

Shown in FIG. 2 is a method 100 to generate one or more templates 200 and delivery mechanisms 300. Templates 200 may be used as an outline for creating or defining a delivery mechanism 300. (See FIG. 3.) In essence, template 200 may be used to define, determine, filter, etc. the content of delivery mechanism 300. Delivery mechanism 300 is the particular format that the user will access or use the content of template 200. For example, delivery mechanism 300 may be a paper form, an electronic form or file, etc. which is used to obtain and record data relating to the content of template 200. Delivery mechanism 300 may be a report having actual data related to the content of template 200 and used to study a population, a flowsheet for trending discrete data, a longitudinal view of data/information having actual data related to the content of template 200 for disease management, etc.

As shown in FIG. 2, method 100 comprises importing data (step 110), extracting data (step 120), defining a template (step 130) and building a delivery mechanism (step 140). According to an exemplary embodiment, method 100 may be performed by one or more components of system 10 described above.

A template 200 (see e.g., FIG. 3, Appendix A, and Appendix B) may be generated using method 100. In order to facilitate creating template 200 (which will be used to generate one or more delivery mechanisms or tools, shown as delivery mechanisms 300, for a medical encounter), new or existing data may be imported into system 10 (step 110). Shown in FIG. 3 is a schematic depiction of data flow of method 100. One or more imported data files 240 may be a starting point or building block for creating template 200. A variety of existing data files 240 (such as existing patient data, patient records, model guidelines from medical associations, mandatory data, guidelines provided by an organization (such as a treating hospital), etc.) may be imported. Furthermore, data files 240 may be user defined or user created. For example, a user may create a data file (having medical content related to one or more medical conditions or types of patient encounters) using a variety of tools such as text editors, word processing programs, XML editors, etc.

According to a particularly preferred embodiment, data file 240 is in an extensible markup language (XML) format. According to an alternative embodiment, the data file(s) may be provided in other file formats which provide identification of fields within the data (e.g., headings, tags, labels, defined fields, etc. by which data within those fields may be identified).

Data file 240 may be obtained or imported from one or more data sources (such as those shown in FIG. 1). For example, data file 240 may be imported from a local hard disk 14, a network file server 18, from an internal web server 22, from various internet sources 24, knowledge banks (such as data base 26), web server 28, etc.

Data file 240 will typically contain clinical content or data related to a medical condition or type of patient encounter. According to various exemplary embodiments, the data file may relate to a variety of medical problems or tasks. According to a particularly preferred embodiment, one or more templates may be imported that relate to the same problem. According to an alternative embodiment, one or more templates may contain any type of data, which is desired to be related.

According to a particularly preferred embodiment, data files 240 are provided in a common data format and/or in accordance with standardized conventions for data types, naming, etc.

Data file 240 will generally have data components (such as data sets or modules) shown in FIG. 3 as components 242. Components 242 are subsets of information related to data file 240 which make up data file 240. For example, components 242 may generally contain information relating to types of subjective patient data, objective patient data, assessment data, and procedure or plan data.

By way of example, shown in APPENDIX A is the XML source for a file 240 which may be imported (among other files) to generate template 200 for use in association with upper respiratory infections. Within file 240 are several components 242 of data elements 270. Components 242 include, among others, a history of present illness (HPI) component 242a, an exam data component 242b, and an assessment/plan component 242c. (The components may have tags or identifiers which identify or name them, etc., and the data fields may also have tags or identifiers which identify the data fields.) As shown in APPENDIX A, within HPI component 242a are several data elements 270, such as data fields for chief complaint, Sx duration, cough description, sore throat description, etc. Exam data component 242b includes various sub-components 267 and data elements 270 such as vitals (e.g., height, weight, temperature, blood pressure (both systolic and diastolic), etc.), ear exam, nose exam, neck exam, etc. Assessment/plan component 242c includes various sub-components 267 and data elements 270 such as medication section, order section, instructions, etc.

According to other exemplary embodiments, one or more of files 240 may be de-identified aggregated patient data. The aggregated patient data will be retrieved on demand depending on the desired medical condition or patient encounter and characteristics of the user for whom the configuration is being done.). As shown in the Appendices, one or more data components 242 may be comprised of other data components (i.e., sub-components or modules) having varying degrees of modularity.

Fields 272 (shown in APPENDIX A and FIG. 3) may be provided for entry of data related to or associated with data elements 270. According to an exemplary embodiment, fields 272 may allow for the manual entry of text, may be one or more predefined responses, selected from pull down menus, pick lists, etc.

Components 242, sub-components 267, elements 270 (or other data sets) may be extracted from file 240 (see FIG. 2, step 120). According to a particularly preferred embodiment, files 240 are provided in an XML format. Accordingly, various data components 242 and/or data elements 270 within file 240 may be identified or tagged with headers and/or footers identifying the data component or data element (such as identifier 280 shown in APPENDIX A). According to a particularly preferred embodiment, software may be used to search file 240 to extract components 242. According to an exemplary embodiment shown in FIG. 3, one or more extracted data components 250 or extracted data elements 252 may be provided for inclusion in template 200.

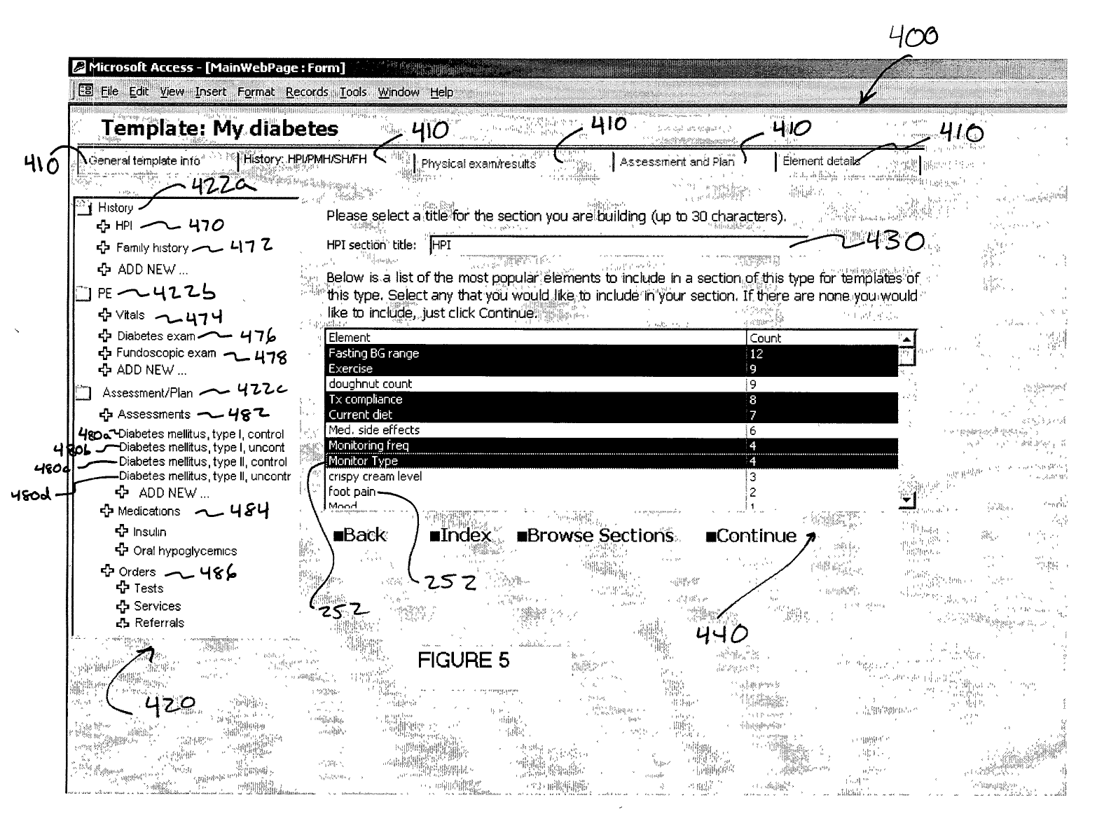

Extracted components 250 or extracted data elements 252 may then be provided to a user to allow the user to define or configure template 200 (see FIG. 2, step 130). System 10 may provide a user with a series of interactive prompts in order to generate template 200. According to a particularly preferred embodiment, a user may be presented with extracted components 250 or extracted data elements 252. The user may select one or more extracted components 250 or extracted data elements 252 to be included in template 200. According to a particularly preferred embodiment, the count or number of occurrences that extracted components 250 or extracted data elements 252 occurred in files 240 may be provided to a user (see FIG. 5). Providing the number of occurrences that extracted components 250 or extracted data elements 252 occurred in templates 240 allows for prioritization in the assembly of template 200 by identifying the most commonly occurring data. According to an alternative embodiment, the number of occurrences that the extracted components or extracted data elements occurred in the files may be used by the system to assemble a template based on a priority schedule (e.g., five most commonly occurring components may be used in the template, etc.).

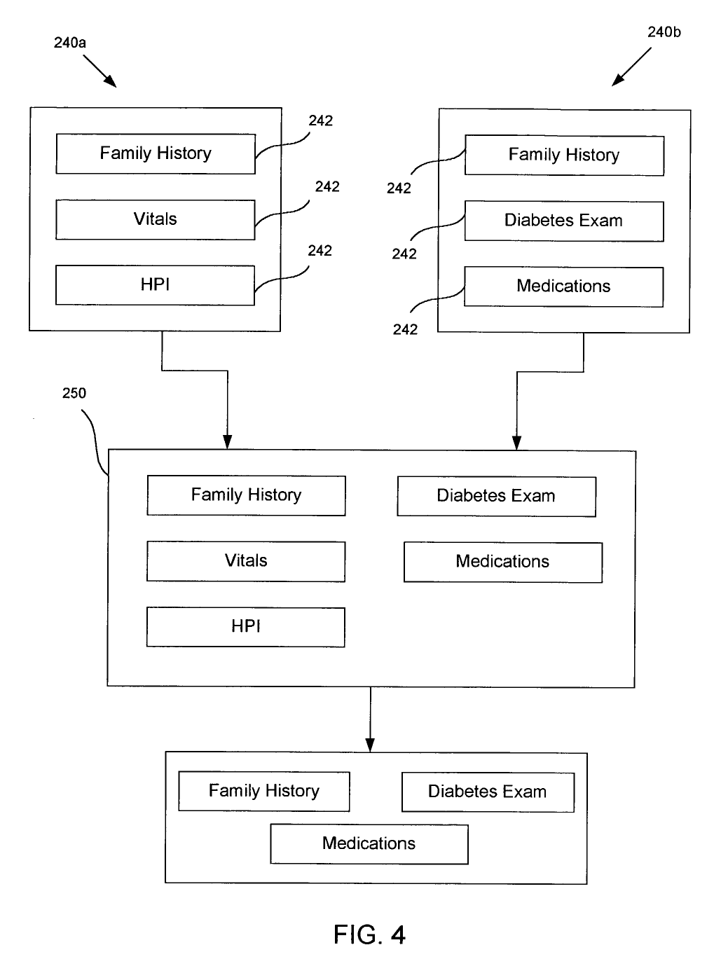

System 10 may be configured to identify any overlap or commonality of extracted components 250 or extracted data elements 252. By way of example shown in FIG. 4, file 240a may be existing patient data and file 240b may be a medical association model guideline for treatment. System 10 may identify any commonality or overlap of data components 242 between files 240a and 240b (i.e., family history) such that there will be no duplicative components or elements used or presented to the user.

According to an exemplary embodiment, a user may further configure template 200 by adding or defining one or more components which were not present in files 240. User may create one or more components not present in files 240 with XML editors, text editors, etc.

Shown in FIGS. 5, and 7 to 19 is a user interface 400 for building or defining a template 200 as described above according to a particularly preferred embodiment. According to this example, template 200 relates to diabetes. According to an exemplary embodiment, user interface may be implemented on a database application such as Microsoft Access.

A template is a collection of medical content that relates to a specific medical conditions or types of patient encounters. The content may consist of a variety of elements: types of subjective history (location of pain, duration of symptoms, etc.), types of objective findings (quality of foot pulses, temperature, cholesterol level), related diagnoses (an upper respiratory template might list pharyngitis, tonsillitis, sinusitis, viral respiratory infection, etc.), medications and dosing for that medical issue, lab tests that are typically done for the issue (throat culture, chest x-ray), educational resources that may be employed for the issue, and advice that might be dispensed for the issue.

Templates may instantiate as various delivery mechanisms. For example, a template may instantiate as a data input form including the listing of treatment options. The template may instantiate as a historic view (or longitudinal view) of the individual patient record, displaying all those medications, labs, objective findings, etc. of that the patient. The template may also instantiate as a population based view showing the number of patients with that condition, a percentage of the population on each of the medications in the template, etc.

User interface 400 may be presented to a user accessing system 10. User interface 400 may be organized as one or more tabs or windows 410 which may be accessed in order to facilitate defining template 200. As shown, windows 410 such as “general template info,” “history,” “physical exam/results,” “assessment and plan,” and “element details” may be provided. The general template information window may provide a user with information relating to authorship information; how it is to be indexed such that related clinical conditions can trigger its use, data hierarchy, etc. The history window may be used to define subjective data fields of the template. The physical exam/results window may be used to define objective data fields of the template. The assessment and plan window may be used to define evaluation, assessment, and treatment (or plan) data of the template. The element details window may be used to define allowable data types for data fields in the delivery mechanism such as numeric, true/false, as well as defining multi-value and single-value fields.

By way of example, building template 200 will be discussed with reference to defining a history component of a diabetes template 200. It should be appreciated that a number of different components of template 200 (including those shown such as physical exam, results, assessment, plan, etc. as well as others not shown) may be configured by a user to define or configure a template 200.

User interface 400 may include a navigation window 420. Navigation window 420 allows a user to view the structure of the various data components which will be used in configuring template 200. According to a particularly preferred embodiment, navigation window 420 is viewable in all of the windows 410 of user interface 400. Navigation window 420 allows a user to view the hierarchy of data which will be used to configure template 200. As shown in FIG. 5, navigation window may have icons 422 which correspond to windows 410. Icon 422 is a graphical representation of a data component to be included in template 200. As described above, data components may have modularity in that a data component may comprise several modular data components. For example, history component 422a is comprised of an HPI component 470 and a family history component 472. The physical exam component 422b is comprised of a vitals component 474, a diabetes exam component 476 and a fundoscopic exam component 478. A user may be presented with an icon to allow them to add a new data component or element to template 200 (shown as +ADD NEW . . . ).

Data elements which are associated with a component may also be graphically represented (shown as icon 480) in window 420. For example, assessment/plan component 422c comprises an assessment component 482, a medications component 484 and an orders component 486. Assessment component 482 comprises data elements 480 shown as a “Diabetes mellitus, type I controlled” data element 480a, “Diabetes mellitus, type I uncontrolled” data element 480b, Diabetes mellitus, type II controlled” data element 480c, and “Diabetes mellitus, type II uncontrolled” data element 480d. It should be appreciated that according to this particularly preferred embodiment, data elements 480a-d may be presented with an associated pick list of selectable data elements or as options for a user to select in delivery mechanism 300. For other data elements (such as a blood pressure data element in the vitals component 474), the data element may be associated with a field which may receive entered text or data (such as words, numbers, etc.).

User interface 400 further includes a data field 430 which allows a user to name a component (or section) which the user is building or compiling.

User interface 400 further includes a window 440 which allows a user to select data elements which are to be included in a specified component (or section) of template 200. As shown in FIG. 5, window 440 provides the name of the element or component (as imported) as well as the number of occurrences that the element appeared in the imported data files. As shown in FIG. 5, six data fields are shown as selected to be included into the HPI component of a diabetes template (i.e., Fasting BG range, Exercise, Tx compliance, Current diet, Monitoring frequency, and Monitor type).

After template 200 has been compiled (e.g., defined, assembled, etc.), template 200 may then be used in conjunction with one or more delivery mechanisms 300 (see FIG. 2, step 140). Delivery mechanism 300 may be a variety of useable embodiments of the content of template 200. For example, delivery mechanism 300 may be an interactive form to be completed during a patient exam; delivery mechanism 300 may be a report which organizes and sorts relevant patient data for a population study; delivery mechanism 300 may be a longitudinal view of a patient as related to one medical condition; etc. As shown in FIG. 3, delivery mechanism 300 is shown as a form. Form 300 will include the content from template 200 as well as fields in which data may be entered related to the template content. For example, as shown in FIG. 3, components 242 from template 200 (shown as A1, B3, B5, D3, E1 and E2) may be provided on form 300, as well as fields for receiving and recording data related to components 242. According to various exemplary embodiments, the form may be provided in an electronic format, paper format, electronic files, etc.

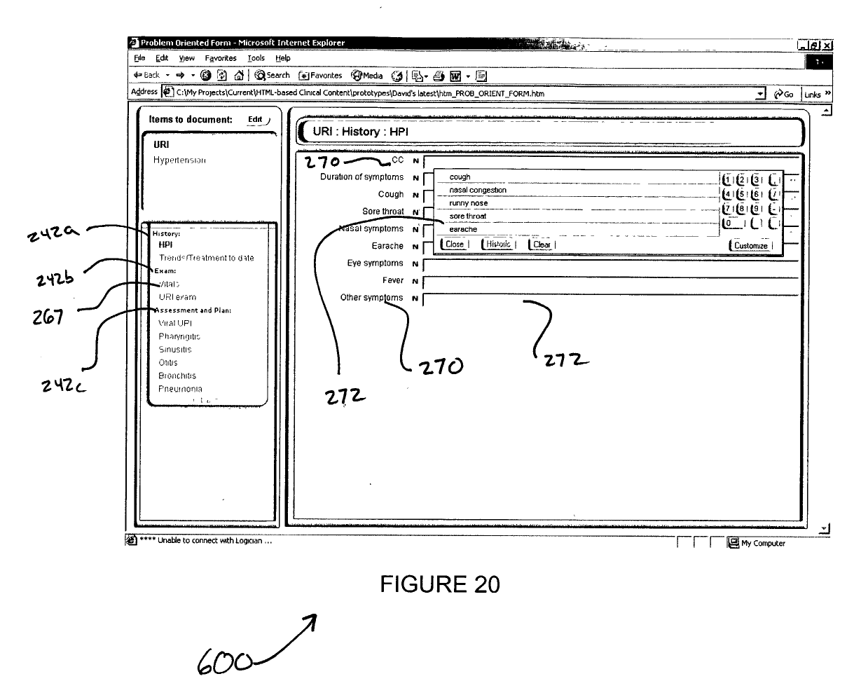

According to another exemplary embodiment shown in FIG. 20, a delivery mechanism is shown as a form 600 created from the template described in APPENDIX A. As shown, HPI component 242a includes the several data elements 270, such as data elements for chief complaint, symptoms duration, cough description, sore throat description, etc. Other data components and elements in Appendix A are provided in form 600. Form 600 further includes fields 272 for entry and storage of data related to or associated with data elements 270. According to an exemplary embodiment, fields 272 may allow for the manual entry of text, may be one or more predefined responses, selected from pull down menus, pick lists, etc.

Another delivery mechanism may be a population report. Template 200 may be used in the preparation of a population report. During the creation of template 200, a user may define various data elements or data modules which would be desirable to include in a population report or study (i.e., data relating to a group of patients with the same condition). Accordingly, a population report may be prepared by having template 200 filter out all non-designated data elements or modules from the relevant data (e.g., de-identified aggregated patient data). Relevant data, corresponding to the data elements or modules which have been designated, will then be provided in the report. According to an alternative embodiment, a user may define various data elements or data modules which would be desirable to include in a population report or study after the template has been built.

Another delivery mechanism may be a longitudinal report (i.e., a report which relates to a single patient, showing relevant data fields over a period of time). During the creation of template 200, a user may define various data elements or data modules which would be desirable to include in a longitudinal report. Accordingly, a longitudinal report may be prepared by having template 200 filter out all non-designated data elements or modules from the relevant data (e.g., a patient's record). Relevant data, corresponding to the data elements or modules which have been designated, will then be provided in the report. According to an alternative embodiment, a user may define various data elements or data modules which would be desirable to include in a longitudinal report after the template has been built.

According to a particularly preferred embodiment, one or more fields 272 are configured to be provided in delivery mechanism 300 (e.g., a form), and receive and/or store inputted data which correlates to data element 270. By way of example, shown in FIG. 4 is field 272a (shown schematically as a text box) which correlates to data field 270a, and 272b (shown schematically as a pick list) which correlates to data field 270b, etc.

According to a particularly preferred embodiment, the form responds to the information in the template. The form acts as a container that hosts the clinical information in the template. For example, in the template, if a users creates a data element that allows multiple values then the form will present the template data for the element as a multi-select list. Furthermore, if the template is updated or changed, those changes will be reflected in the form.

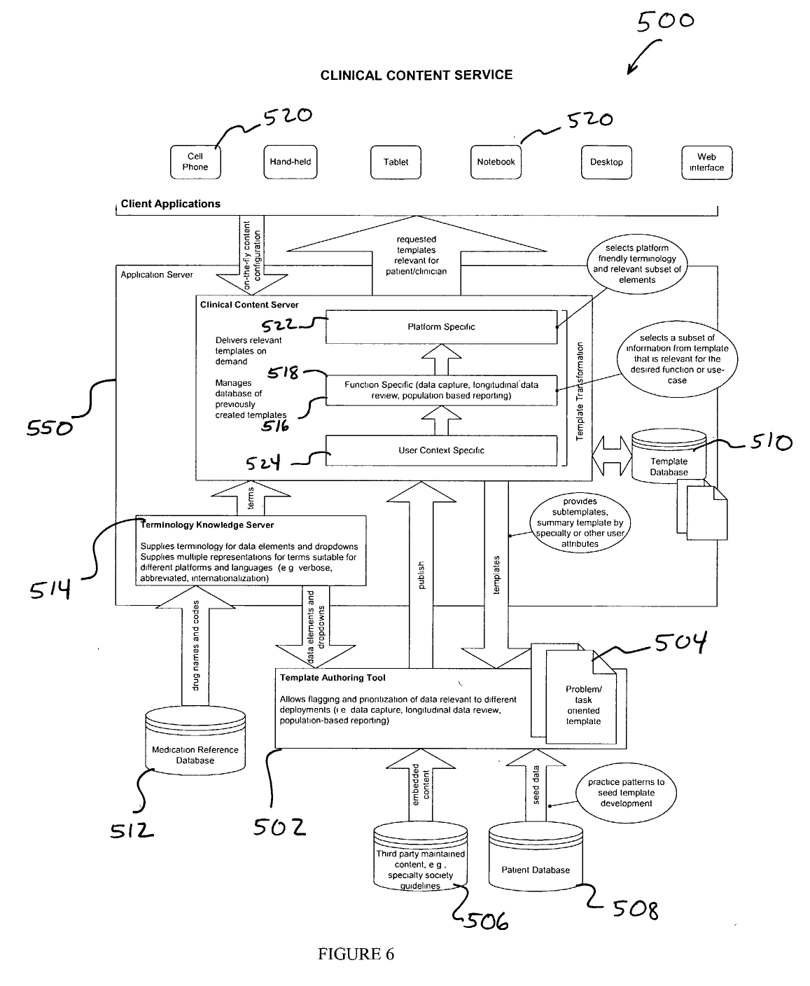

Shown in FIG. 6 is a schematic representation of a medical template management system 500 according to another exemplary embodiment. System 500 comprises a template creation and configuration tool 502. Template creation tool 502 creates and maintains one or more templates 504 for use related to a medical condition, patient encounter, or task.

Template creation tool 502 is in communication with a variety of data sources such as third party maintained content (typically a medical specialty society guideline shown as data source 506), patient databases 508, as well as previously created templates (shown as server 510), and medication reference databases 512.

According to a particularly preferred embodiment, data from data source 506, patient database 508, server 510 and medication reference data base 512 will be provided in standardized formats. For example, the data will be stored in defined or agreed upon formats, use appropriate naming conventions, appropriately name data components or elements, etc. According to a particularly preferred embodiment, imported data will comply with formats and standards set forth by the standards organizations such as ASTM (Arden Syntax) and cooperative efforts such as the Institute for Medical Knowledge Implementation (IMKI). According to various alternative embodiments, the template creation tool may be in communication with a variety and combination of data sources including third party servers, internal data sources, user created data sources, etc. in a variety of different formats.

Template creation tool 502 allows for a user to identify relevant medical data (or content) and implement that data in various tools, delivery mechanisms, or applications such as data recordation, reporting or summarizing data sets, outlining interview procedures, etc.

Template creation tool 502 is configured to extract (or mine) data from the various data sources (e.g., data source 506, patient database 508, server 510, etc.) to assist in creating a template 504. Extracted data from data source 506, patient database 508, and/or server 510 will typically relate to a medical condition (such as diabetes, heart disease, etc.). Extracted data may be a wide variety of data types, such as examination data which is obtained during an exam, orders related to the condition, medications related to the condition, assessments related to the condition, family history, history of present illness, tests to be run associated with the condition, etc. A server 514 (shown as a terminology knowledge server) may be coupled to the template creation tool 502 in order to provide a way to control the terms or names used to build the template. Server 514 functions to interpret various names which may not comply with naming guidelines, into a consistent naming convention. Server 514 may be provided to ensure proper naming conventions for any data source of template creation tool 502.

Extracted data may have varying degrees of modularity. For example, extracted data may be a module of various associated data elements, associated sub-modules, etc.

Data extracted from data source 506, patient database 508, and/or server 510 may be presented to a user in a user interface (such as one shown in FIG. 5). A user may configure the template to include one or more selected data elements. Alternatively, a template may be generated without user input or configuration.

As shown in FIG. 6, the template is saved to server 510 for later use.

Utilization of patient data provides several advantageous features. One such advantageous feature is that importing actual patient data efficiently provides a model of actual interviews or tasks which have been conducted, thus allowing the model template to be more efficiently assembled. For example, importing actual patient data related to a medical condition provides valuable content to build the template. Questions which have been asked, data which has been obtained, medications which have been prescribed, diagnoses made, etc. are provided to the template creation tool as a starting point in creating the template. Similarly, importing actual task data may be used to outline or model tasks which have been conducted, such as order sets, lab test sets, etc.

Once the template has been assembled with the appropriate data elements, the template may then be configured for different functions to provide different delivery mechanisms 516 to a user (see step 518) such as by an application server 550. For example, the content of the template may be used to generate a delivery mechanism (e.g. a form) used in a medical encounter.

Similarly, delivery mechanism 516 may be a report. The templates for a given condition have the data elements flagged that are relevant to longitudinal views for disease management or population-based reporting on quality of care. For example, when documenting a patient encounter for diabetes it may be important to document which glucose home monitor the patient is using in addition to seeing what their last glucose (blood sugar) value was. However, for population based reporting, the glucose values are relevant, but not the type of glucose monitor. The template allows a user to define or identify which data elements of components are relevant for the use, and then the selected data is provided to the appropriate delivery mechanism.

System 500 is also configured to provide a platform specific view of delivery mechanism 516 (see step 522). For example, if a user implements delivery mechanism 516 on a cell phone, the user may only need a certain level or degree of specificity in the data (e.g., a user may only desire to review the ten most frequently occurring data elements in the assembled template). Alternatively, user may implement delivery mechanism 516 on a desktop computer system and be provided with all amount and content of delivery mechanism 516. The amount and type of content in delivery mechanism 516 may vary depending on the platform which it will be used. As shown, platform 520 may be a cell phone, a hand held computer, a personal digital assistant, a tablet computer, a notebook computer, a desk top system, a web site interface, etc.

According to a particularly preferred embodiment, a different number of templates may be used in preparing delivery mechanism 516 (see step 524). Depending on a user's nature of practice, the user may desire to have, the delivery mechanism prepared in accordance with different templates related to the same medical condition. By way of example, a user needing a delivery mechanism related to diabetes may select a user specified template created related to that problem. Alternatively, the user may select a template created for a specialist in that field. Alternatively, the user may select a template created for a generalist related to the condition or encounter.

It should be appreciated that the systems and methods disclosed allow for user configuration of templates and delivery mechanisms for use in medical encounters. However, the systems and methods disclosed also allow an enterprise (such as a treating hospital) to include specified or mandatory data in a template and delivery mechanisms.

The systems and methods disclosed further provide for the modularization of content. That is, the content of the template can be integrated or implemented into multiple forms while requiring updates or changes be entered to a single template (and accordingly, allowing the multiple forms to be updated as well).

The systems and method disclosed further provide for the externalization or separation of template content. That is, the content of the template may be separated from the user interface, thus allowing the content of the template to be compiled or built once and applied many times for a variety of different purposes (i.e., the content of the template may be applied for a variety of different purposes as different delivery mechanisms such as forms, reports, etc.).

The systems and method disclosed further provide for the modularization of content. That is, the content of the template can be integrated or implemented into many forms while updates or changes may be made to a single template.

While the embodiments illustrated in the figures and described above are presently preferred, it should be understood that these embodiments are offered by way of example only. While exemplary embodiments describe the invention in the context of clinical template management, the invention may extend to other areas clinical management. The invention is not limited to a particular embodiment, but extends to various modifications, combinations, and permutations that nevertheless fall within the scope and spirit of the appended claims.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

What is claimed is:

1. A system for creating a clinical template for at least one medical condition or encounter, the system comprising:
a processing unit;
a memory portion in communication with the processing unit having information stored therein to configure the processing unit to:
receive a first data set relating to the medical condition or encounter;
extract at least two data elements from the first data set;
provide the at least two data elements to a user to select data elements;
receive an indicator of data elements selected by the user; and
include the selected data elements into the clinical template.

2. The system of claim 1 wherein the memory portion is further configured to generate a delivery mechanism from the template.

3. The system of claim 2 wherein the delivery mechanism is a form.

4. The system of claim 3 wherein the form is at least one of a data entry form and a data review form.

5. The system of claim 2 wherein the delivery mechanism is a report.

6. The system of claim 5 wherein the report is at least one of a patient disease management report and a population based disease management report.

7. The system of claim 2 wherein the delivery mechanism is configured to be used on at least one of a cell phone, a hand held computer, a tablet computer, a notebook computer, a desktop computer and a web site interface.

8. The system of claim 7 wherein the first data set contains at least one of existing patient data, existing template data, user defined data, enterprise guidelines, medical society guidelines, and national guidelines.

9. The system of claim 1 wherein the processing unit is further configured to:
receive a second data set relating to the medical condition or encounter;
extract at least two data elements from the second data set;
provide the at least two data elements from the second data set to the user to select data elements;
receive an indicator of data elements from the second data set selected by the user; and
include the selected data elements from the second data set into the clinical template.

10. The system of claim 1 wherein each of the at least two data elements further comprises a set of data elements.

11. The system of claim 10 wherein the set of data elements further comprises a data component.

12. A method for generating a clinical template for at least one medical condition or encounter, the method comprising:
receiving a first data set related to the medical condition or encounter;
extracting at least two data elements from the first data set;
providing the at least two data elements to a user to select data elements;
receiving an indicator of data elements selected by the user; and
including the selected data elements into the clinical template.

13. The method of claim 10 further comprising generating a delivery mechanism from the template.

14. The method of claim 13 wherein the delivery mechanism is a form.

15. The method of claim 13 wherein the delivery mechanism is a report.

16. The method of claim 10 wherein the delivery mechanism is configured to be used on at least one of a cell phone, a hand held computer, a tablet computer, a notebook computer, a desktop computer and a web site interface.

17. The method of claim 10 wherein the first data set contains at least one of existing patient data, existing template data, user defined data, enterprise guidelines, medical society guidelines, and national guidelines.

18. The method of claim 16 further comprising:
receiving a second data set relating to the medical condition or encounter;
extracting at least two data elements from the second data set;
providing the at least two data elements from the second data set to the user to select data elements;
receiving an indicator of data elements from the second data set selected by the user; and
including the selected data elements from the second data set into the clinical template.

19. A system for generating a clinical template for at least one medical condition or encounter, the system comprising:
a first computer system;
a second computer system in communication with the first computer system;
wherein the second computer system is configured to receive a first data set relating to the at least one medical condition or encounter from the first computer system; and
wherein the second computer system is configured to generate the clinical template from the first data set.

20. The system of claim 19 wherein the second computer system is further configured to receive a second data set relating to the at least one medical condition or encounter, and wherein the second computer system is configured to generate the medical template from the first data set and the second data set.

21. The system of claim 20 wherein the second computer system is further configured to receive a third data set relating to the at least one medical condition or encounter from a third computer system, and wherein the second computer system is configured to generate the medical template from the first data set, the second data set, and the third data set.

22. The system of claim 19 wherein the first data set is at least one of enterprise guidelines, medical society guidelines, medical society checklists, existing patient data, user defined data, and existing template data.

23. The system of claim 19 wherein the second computer system is further configured to generate a delivery mechanism for use by a user.

24. The system of claim 23 wherein the delivery mechanism is one of a form and a report.
